(19) United States
(12) Patent Application Publication
(10) Pub. No.: US 2020/0081533 A1
(43) Pub. Date: Mar. 12, 2020

(54) WEARABLE DEVICE HAVING REGIONS OF VARYING STIFFNESSES

(71) Applicant: Microsoft Technology Licensing, LLC, Redmond, WA (US)

(72) Inventors: James David HOLBERY, Bellevue, WA (US); Kelly Marie BOGAN, Redmond, WA (US); Siyuan MA, Bothell, WA (US); Sang Ho YOON, Redmond, WA (US)

(73) Assignee: Microsoft Technology Licensing, LLC, Redmond, WA (US)

(21) Appl. No.: 16/124,834

(22) Filed: Sep. 7, 2018

(51) Int. Cl. G06F 3/01; D03D 1/00

(52) U.S. Cl. CPC G06F 3/014; G06F 3/016; D10B 2401/18; D10B 2401/062; D03D 1/0088

(57) ABSTRACT

Examples are disclosed that relate to a wearable device having flexible regions of varying stiffnesses for accommodating both wearability and input/output device performance. One example provides a wearable device comprising a first region of flexible material having a lesser stiffness, a second region of flexible material contiguous with the first region of flexible material and having a greater stiffness, and an input and/or output device mounted to the second region of flexible material.

### BACKGROUND

Wearable electronic devices may take many forms, such as wrist-worn and head-worn forms. Such devices often include rigid cases housing electronic components, and flexible portions for mounting to a human body. Often, input and output device are also housed in the rigid cases of such devices.

### SUMMARY

Examples are disclosed herein that relate to a wearable device having flexible regions of varying stiffnesses for accommodating both wearability and input/output device performance. One example provides a wearable device comprising a first region of flexible material having a lesser stiffness, a second region of flexible material contiguous with the first region of flexible material and having a greater stiffness, and an input and/or output device mounted to the second region of flexible material.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B show an example wearable device in the form of a glove having regions of varying stiffnesses.

FIGS. 2-5 shows example structures of regions of greater stiffness that may be integrated into a textile of a wearable device.

FIG. 6 shows an example wearable device comprising a motion restricting device.

FIG. 7 shows a block diagram of an example computing system.

### DETAILED DESCRIPTION

As mentioned above, many wearable devices, such as head-mounted devices and wrist-mounted devices, include a rigid body that houses electronic components such as input and output devices. However, some wearable devices may be designed to position input and/or output devices at flexible locations of the devices. As an example, a wearable device in the form of an electronically functional textile glove may include one or more haptic output devices to provide vibrational outputs at locations along fingers of the glove, the back of the hand, and/or palm, and/or may include motion-restricting mechanisms (e.g. electrostatic clutches, electrorheological devices, magnetorheological devices, mechanical motion restriction devices, etc.) to apply pulling, pushing, and/or locking forces to a user's fingers.

However, attaching such devices to flexible portions of a wearable device may pose challenges. For example, mounting a haptic or other mechanical device to a flexible portion of a wearable device may result in output energy (e.g. vibrational energy, mechanical motion, etc.) of the device being attenuated by the flexible glove, thereby dampening an effect of the output device as perceived by a user.

Accordingly, examples are provided herein that relate to a wearable device having regions of varying stiffnesses for accommodating both the mounting of an input and/or output device and wearability. As explained in more detail below, a wearable device may have a first region of flexible material (e.g. a first textile region) having a lesser stiffness, a second region of flexible material (e.g. a second textile region) contiguous with the first region and having a greater stiffness, and an input and/or output device mounted to the second region. As one example, the first and second regions may comprise a same textile material, but the second region may have a polymer integrated with the textile to increase the stiffness of the second region. As another example, the second flexible region may comprise a different textile formed by weaving or knitting the second region with different yarn and/or using different knitting/weaving parameters than the first region (e.g. a higher density of yarns in the second region). Such techniques may allow an input and/or output device to be attached to stiffer portions of a flexible textile to more allow for the more efficient operation of input and output devices (e.g. better energy transfer for and less attenuation of haptic output devices), while maintaining an overall flexible and conformal structure for a wearable device.

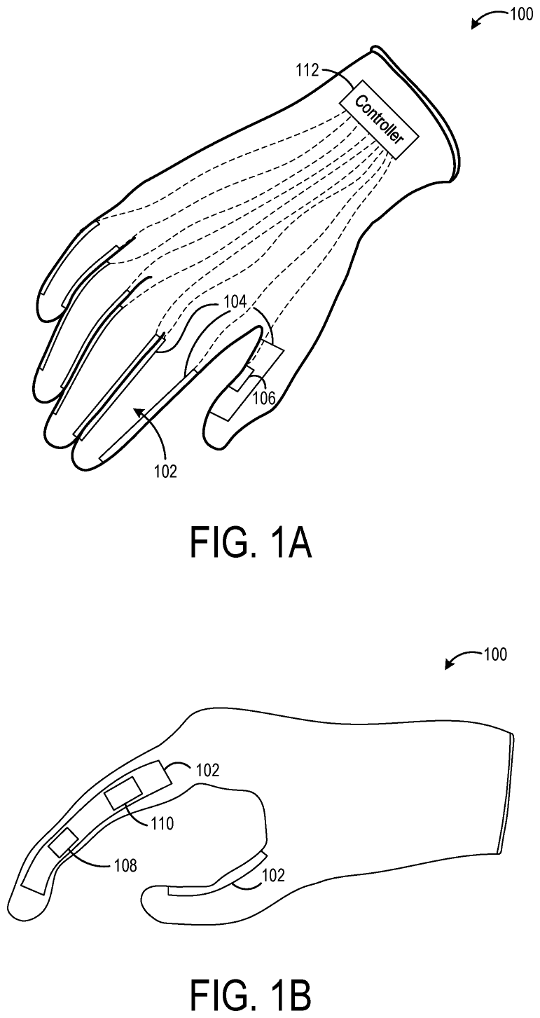

FIGS. 1A and 1B respectively show a top view and a side view of an example wearable device 100 in the form of a glove. Wearable device 100 has at least a first region 102 of flexible material having a lesser stiffness and a second region 104 of flexible material having a greater stiffness. The flexible material of each region may comprise a textile, such as a knitted fabric, woven fabric, or non-woven fabric. The flexible material of the second region 104 may comprise a reinforced portion of the same material as the first region, and/or may comprise a different material (e.g. different yarn density, different yarn materials, different weave/knit pattern, etc.).

In the example of FIG. 1, the region(s) of lesser stiffness are located in regions of the glove corresponding to the top of the fingers and knuckles, while regions of greater stiffness are located in regions of the glove corresponding to sides of fingers. The multi-compliance construction of the glove may help to maintain conformity and comfort of the wearable device 100 with a wearer's hand as the user's hand is moved (e.g. to allow the glove to stretch at the knuckles when a user's fingers are flexed), while providing stiffer areas on the sides of the finger for mounting of input and/or output devices, illustrated schematically as devices 106, 108 and 110. Example devices that may be incorporated into the wearable device 100 at these positions include haptic (e.g. vibratory) output devices, as the stiffer flexible region at which the haptic devices are mounted may more efficiently distribute and transfer vibration to a user's skin. In other examples, a wearable device may include flexible regions of greater and lesser stiffness at any other suitable locations to support the mounting of any suitable input and/or output devices. Examples of other input/output devices include a selective motion restriction device, a motor, a controller, a camera, a microphone, a speaker, a touch input device, a light, a display, etc. A controller 112 located on the wearable device 100 may be configured to provide control signals to each of the input and/or output devices 106, 108 and 110. In some examples, devices 106, 108, and 110 may be mounted directly to the material forming the second flexible region, or may be mounted to another structure (e.g. a flexible circuit board or other substrate) that in turn is mounted to the material forming the second region.

A multi-compliance textile of varying stiffnesses may be formed in any suitable manner. In some examples, as mentioned above, a same textile material may be used to form the regions of the lesser stiffness and greater stiffness and may include a polymer material integrated with the fabric material in the flexible regions having a greater stiffness. The polymer composite regions of such a wearable device may be formed in any suitable manner. Examples include insert molding of the textile into a thermoplastic stiffening material via injection molding, application of a curable or thermosetting polymer or polymer precursor mixture to the second region (e.g. by casting a liquid precursor mixture or molten polymer in a suitable mold), and application of a preformed thermoplastic stiffener to the textile via heat. In some examples, the polymer may be integrated with the textile prior to forming the textile into the wearable article, while in other examples the polymer may be integrated with the textile after forming the textile article.

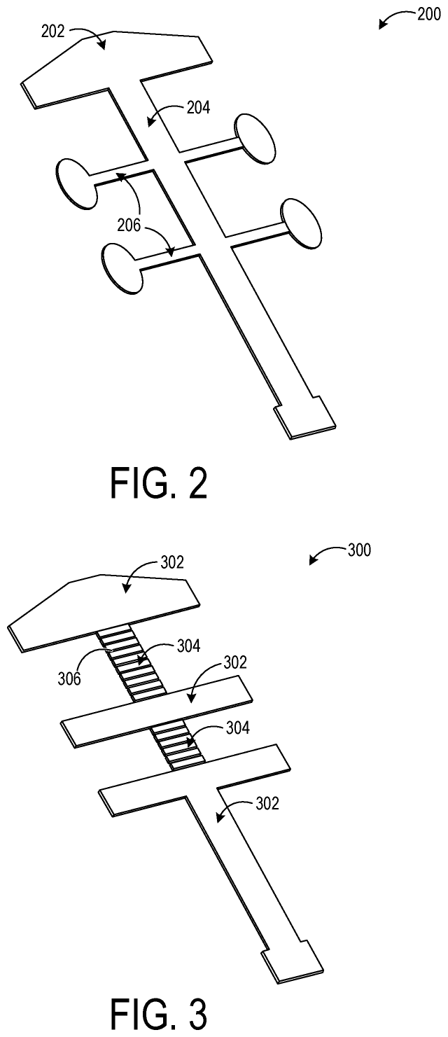

FIGS. 2-5 show example shapes of reinforcing structures that can be integrated with a textile used to form a glove device, or with a glove device formed from a textile, to stiffen selected regions of the glove device. The depicted structures may be formed via a polymer integrated into the textile of the glove device, and/or from a stiffer textile structure than used in other portions of the device. Each structure is shown in a flattened configuration separate from the glove device for clarity. First, FIG. 2 shows an example structure 200 that may be integrated with a finger portion of a glove to stiffen selected regions of the glove. The structure 200 includes a tip 202 that corresponds to a fingertip of the glove, a trunk 204 that runs along a length of the finger, and side tabs 206 that may wrap around the finger, e.g. in between knuckles of the finger. Structure 200 may be used, for example, to distribute vibrational energy from a haptic output device along a length of a finger by the glove regions that integrate stiffening structure 200 while still allowing the finger to freely flex via the less stiff regions, and/or for attaching a motion restriction device to finger locations that span skeletal joints. Similar structures may be used to direct haptic vibration outputs to any other desired portions of a finger. For example, a stiffening structure may be configured as a small area located only at a fingertip of a glove. A haptic output device mounted at this location would be perceived as having a highly localized effect. As another example, a stiffening structure may have a web-like structure to distribute vibrations from a haptic output device throughout the glove.

Structure 200 may be integrated into a finger of a textile glove in any suitable manner, and may be formed from any suitable material. In some examples, structure 200 is formed from a polyurethane material. A polyurethane precursor mixture may be dispensed into a mold to form structure 200, and then partially cured in the mold. The structure 200 then may then be pressed onto the surface of the textile with the application of heat to complete the curing and bond the polyurethane to the textile. The textile then may be formed into a glove by cutting, sewing, and/or any other suitable steps. Other polymers than polyurethanes also may be used, such as polyacrylates and polycarbonates. In other examples, instead of producing a pre-formed polymer structure and then integrating it into a textile before shaping the textile, the polymer may be cast or molded directly onto a pre-shaped textile.

In some examples, a region of textile having a greater stiffness may have sub-regions with different stiffnesses. FIG. 3 shows an example stiffening structure 300 similar to structure 200, but with sub-regions of different stiffnesses. Structure 300 is shown in a flattened view and apart from a glove for clarity. Structure 300 comprises sub-regions 302 of a first stiffness, and sub-regions 304 of a second stiffness. Thus, when incorporated into a glove, the glove will have regions of lesser stiffness without polymer, regions of intermediate stiffness corresponding to sub-regions 304, and regions of greater stiffness corresponding to regions 302. In this specific example, the sub-regions 304 of the intermediate stiffness may be more flexible and stretchable in a first direction along the length of the finger and less stretchable in a perpendicular direction due to grooves 306 formed in the structure 300.

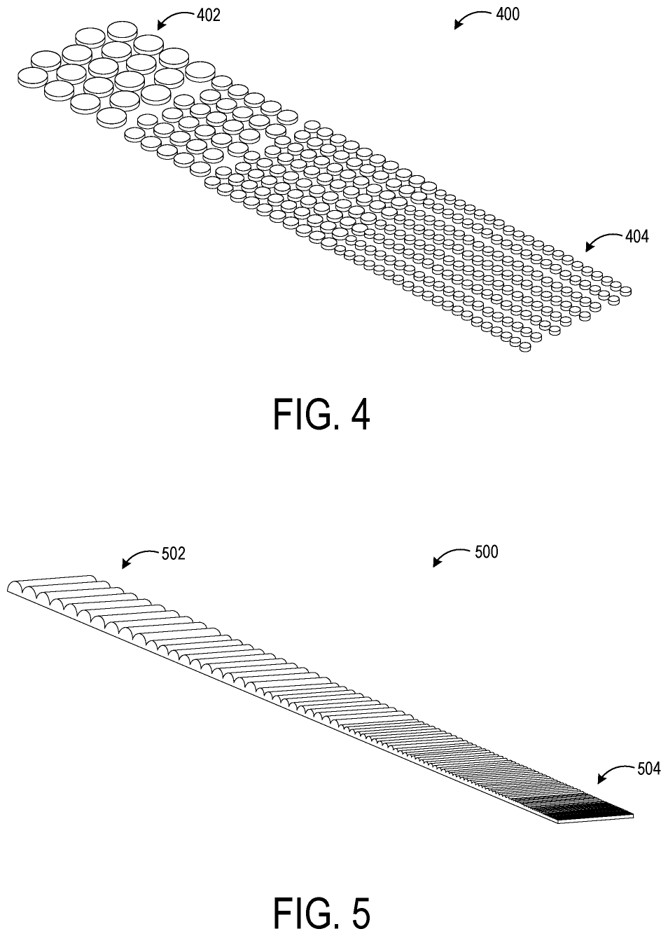

In some examples, a stiffness of a polymer composite region of a wearable device may vary along one or more directions, for example, by varying a quantity of polymer per unit area integrated with the textile along the direction. FIGS. 4 and 5 show example stiffening structures 400 and 500 that may be incorporated into a textile for a wearable device, such as along a finger of a glove device. In these examples, each structure 400, 500 comprises a polymer quantity gradient along a direction. First regarding FIG. 4, the stiffening structure 400 comprises small circular polymer structures that are larger in diameter at one end 402 and decrease in size along a direction toward the opposite end 404. Referring next to FIG. 5, the stiffening structure 500 comprises a consistent width along its length, but has a thicker amount of the polymer at one end 502, and decreases in thickness along a direction toward the opposite end 504. In each of these examples, the stiffening structure may provide a greater amount of stiffness where there is a greater quantity of polymer, and a lesser amount of stiffness where there is a lesser quantity of polymer. Stiffness as a function of position may be varied in other manners as well, such as by varying durometer, density, and/or other suitable property or properties of the polymer and polymer structures along a desired direction.

In other examples, areas of a wearable device of varying stiffness may be formed by varying a density of a textile used to make the device, in addition to or as opposed to integrating a polymer with the textile. A density of a textile may be varied in any suitable manner, such as by changing the stitch used, using a different knitting/weaving technique, changing the size of knitting needles used, increasing or decreasing the thread count, etc. In some examples, a flat-bed knitting machine may be used to knit a textile having different types of yarns (e.g. different regions may have varied quantities of cotton, polyester, wool, etc., each of which may have different densities and yarn stiffnesses), and/or different spacing between yarns in a single pass of the machine.

The degree of stiffness of a region of textile may be chosen based upon a type of device intended to be mounted to the region. For example, a relatively higher stiffness may be used for a piezo-haptic output device, while a relatively lower stiffness may be used for a polymer haptic device.

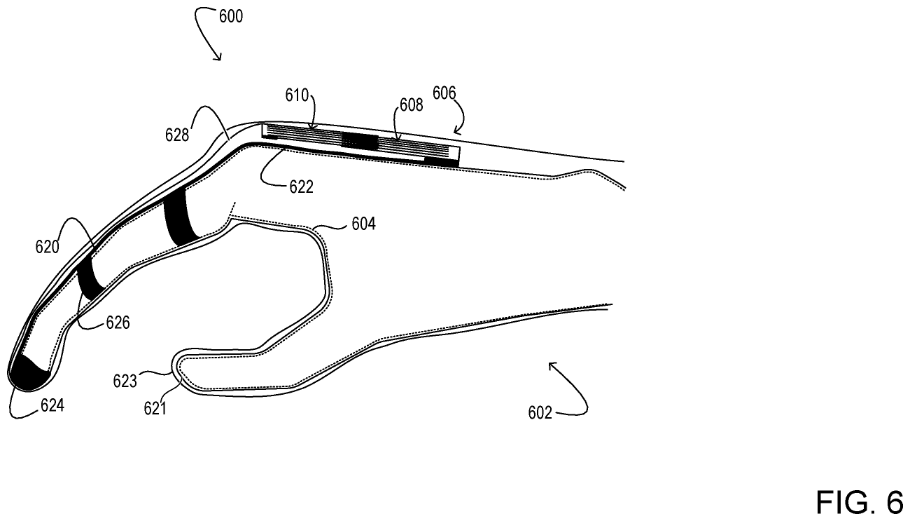

As another example, a textile of a glove device or other wearable device may be configured to have a high degree of stiffness and low stretch in regions at which a motion-restricting device interfaces the textile. FIG. 6 shows an example motion-restricting device 600 integrated with a glove device 602 that is worn on a hand 604 of a user. The depicted motion-restricting device comprises an electrostatic clutch 606 controllable to change a frictional force between two or more electrode sheets of a first electrode 608 and two or more electrode sheets of a second electrode 610 that are positioned alternately in a stacked arrangement and are moveable translationally with respect to each other. By increasing a charge differential between the electrodes, a frictional force between the electrode surfaces can be increased, thereby increasing an oppositional force to electrode translation. By coupling the first and second electrodes to different sides of a skeletal joint, a resistive force to motion of the joint may be varied. In other examples, any other suitable motion-restricting device may be used, including cable-driven, magnetic-driven, and other electrostatic-driven devices. Further, other input and/or output devices may be mounted selectively on a stiffer region or less stiff flexible region. For example, an inertial motion sensor may be mounted to a relatively stiffer surface to help maintain a desired accuracy of motion sensing (e.g. in the example of a glove device, to avoid being moved to a different location relative to a user's hand by textile stretching). As another example, for arrays of light sources used for optical tracking of a wearable device, mounting the light sources to a more rigid portion of the wearable device may facilitate tracking by maintaining a well-defined geometry relative to the model, which may facilitate fitting an observed pattern of lights to a three-dimensional model of the lights.

Glove device 602 comprises an integrated polymer stiffening structure 620 similar to that shown in FIG. 2. Integrated stiffening structure 620 is integrated into an inner textile layer 621 of the glove, and the motion restriction device 600 is located between the inner textile layer 621 and an outer textile layer 623. Structure 620 comprises a trunk 622 that extends along a topside (i.e. opposite a palm-side) of a user's finger, a tip 624 that wraps around an end of a finger, and side tabs 626 that wrap around the finger between the knuckles. The second electrode 610 is coupled to a flexible ribbon 628 that extends along a length of a finger portion of the wearable device and attaches to the stiffening structure 620 at least at the tip 624. As the clutch 606 is attached at two more locations along the stiffening structure 620, a force exerted by the clutch 606 will be efficiently transferred to the finger, as opposed to being attenuated by fabric stretch/deformation/etc.

In some embodiments, the methods and processes described herein may be tied to a computing system of one or more computing devices. In particular, such methods and processes may be implemented as a computer-application program or service, an application-programming interface (API), a library, and/or other computer-program product.

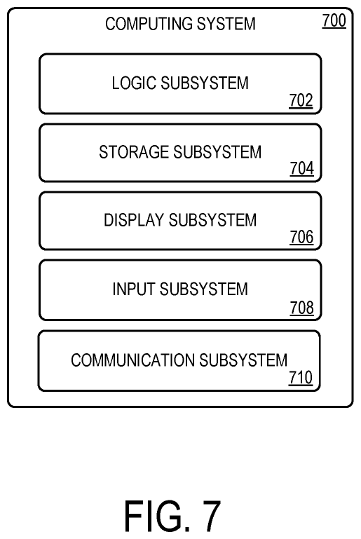

FIG. 7 schematically shows a non-limiting embodiment of a computing system 700 that can enact one or more of the methods and processes described above, such as controlling input/output devices coupled with a wearable device. Computing system 700 is shown in simplified form. Computing system 700 may take the form of one or more personal computers, server computers, tablet computers, home-entertainment computers, network computing devices, gaming devices, mobile computing devices, wearable computing devices, mobile communication devices (e.g., smart phone), and/or other computing devices. Computing system 700 may represent wearable device 100 or any suitable computing device incorporating textile regions of varying stiffnesses, as described herein.

Computing system 700 includes a logic subsystem 702 and a storage subsystem 704. Computing system 700 may optionally include a display subsystem 706, input subsystem 708, communication subsystem 710, and/or other components not shown in FIG. 7.

Logic subsystem 702 includes one or more physical devices configured to execute instructions. For example, the logic subsystem 702 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem 702 may include one or more processors configured to execute software instructions. Additionally or alternatively, the logic subsystem 702 may include one or more hardware or firmware logic machines configured to execute hardware or firmware instructions. Processors of the logic subsystem 702 may be single-core or multi-core, and the instructions executed thereon may be configured for sequential, parallel, and/or distributed processing. Individual components of the logic subsystem 702 optionally may be distributed among two or more separate devices, which may be remotely located and/or configured for coordinated processing. Aspects of the logic subsystem 702 may be virtualized and executed by remotely accessible, networked computing devices configured in a cloud-computing configuration.

Storage subsystem 704 includes one or more physical devices configured to hold instructions executable by the logic subsystem 702 to implement the methods and processes described herein. When such methods and processes are implemented, the state of storage subsystem 704 may be transformed—e.g., to hold different data.

Storage subsystem 704 may include removable and/or built-in devices. Storage subsystem 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 704 may include volatile, nonvolatile, dynamic, static, read/write, read-only, random-access, sequential-access, location-addressable, file-addressable, and/or content-addressable devices.

It will be appreciated that storage subsystem 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 702 and storage subsystem 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 706 may be used to present a visual representation of data held by storage subsystem 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic subsystem 702 and/or storage subsystem 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

Another example provides a wearable device comprising a first region of flexible material having a lesser stiffness, a second region of flexible material contiguous with the first region of flexible material and having a greater stiffness, and an input and/or output device mounted to the second region of flexible material. In such an example, the input and/or output device alternatively or additionally may comprise a haptic output device. In such examples, the input and/or output device alternatively or additionally may comprise a motion restriction device. In such examples, the first region of flexible material alternatively or additionally may comprise a textile, and the second region of flexible material alternatively or additionally may comprise a polymer integrated with the textile. In such examples, the polymer alternatively or additionally may comprise a polyurethane. In such examples, the polymer alternatively or additionally may comprise a quantity gradient along at least one direction of the second region of flexible material. In such examples, the second region alternatively or additionally may comprise a higher density textile material than the first region. In such examples, the wearable device alternatively or additionally may comprise a glove. In such examples, the input and/or output device alternatively or additionally may be mounted directly to the second region of flexible material. In such examples, one or more of the first region and the second region alternatively or additionally may be more stretchable in a first direction and less stretchable in a second direction.

Another example provides a wearable device comprising a first region of flexible material having a lesser stiffness, a second region of flexible material contiguous with the first region of flexible material and having a greater stiffness, and a haptic output device mounted to the second region of flexible material. In such an example, the first region of flexible material alternatively or additionally may comprise a textile, and the second region alternatively or additionally may comprise a polymer integrated with the textile. In such examples, the polymer may comprise a polyurethane. In such examples, the polymer alternatively or additionally may comprise a quantity gradient along at least one direction of the second region of flexible material. In such examples, the second region alternatively or additionally may comprise a higher density textile material than the first region. In such examples, the wearable device may comprise a glove.

Another example provides a wearable device comprising a fabric region of a textile having a lesser stiffness, a polymer composite region of the textile having a greater stiffness and a polymer integrated with the textile, and an input/output device mounted to the polymer composite region of the textile. In such examples, the polymer alternatively or additionally may comprise a quantity gradient along at least one direction of the second region of flexible material. In such examples, the input/output device alternatively or additionally may comprise one or more of a haptic output device, a selective motion restriction device, a motor, a controller, and a camera. In such examples, the wearable device may comprise a glove.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A wearable device comprising
a first region of flexible material having a lesser stiffness;
a second region of flexible material contiguous with the first region of flexible material and having a greater stiffness; and
an input and/or output device mounted to the second region of flexible material.

2. The wearable device of claim 1, wherein the input and/or output device comprises a haptic output device.

3. The wearable device of claim 1, wherein the input and/or output device comprises a motion restriction device.

4. The wearable device of claim 1, wherein the first region of flexible material comprises a textile, and wherein the second region of flexible material comprises a polymer integrated with the textile.

5. The wearable device of claim 4, wherein the polymer comprises a polyurethane.

6. The wearable device of claim 4, wherein the polymer comprises a quantity gradient along at least one direction of the second region of flexible material.

7. The wearable device of claim 1, wherein the second region comprises a higher density textile material than the first region.

8. The wearable device of claim 1, wherein the wearable device comprises a glove.

9. The wearable device of claim 1, wherein the input and/or output device is mounted directly to the second region of flexible material.

10. The wearable device of claim 1, wherein one or more of the first region and the second region is more stretchable in a first direction and less stretchable in a second direction.

11. A wearable device comprising
a first region of flexible material having a lesser stiffness;
a second region of flexible material contiguous with the first region of flexible material and having a greater stiffness; and
a haptic output device mounted to the second region of flexible material.

12. The wearable device of claim 11, wherein the first region of flexible material comprises a textile, and wherein the second region comprises a polymer integrated with the textile.

13. The wearable device of claim 12, wherein the polymer comprises a polyurethane.

14. The wearable device of claim 12, wherein the polymer comprises a quantity gradient along at least one direction of the second region of flexible material.

15. The wearable device of claim 11, wherein the second region comprises a higher density textile material than the first region.

16. The wearable device of claim 11, wherein the wearable device comprises a glove.

17. A wearable device comprising:
a fabric region of a textile having a lesser stiffness;
a polymer composite region of the textile having a greater stiffness and a polymer integrated with the textile; and
an input/output device mounted to the polymer composite region of the textile.

18. The wearable device of claim 17, wherein the polymer comprises a quantity gradient along at least one direction of the second region of flexible material.

19. The wearable device of claim 17, wherein the input/output device comprises one or more of a haptic output device, a selective motion restriction device, a motor, a controller, and a camera.

20. The wearable device of claim 17, wherein the wearable device comprises a glove.
